(19) United States
(12) Patent Application Publication
(10) Pub. No.: US 2019/0007265 A1
(43) Pub. Date: Jan. 3, 2019

(54) NETWORK SETTING INFORMATION GENERATION METHOD AND NETWORK SETTING INFORMATION GENERATION DEVICE

(71) Applicant: Yamaha Corporation, Hamamatsu-shi (JP)

(72) Inventors: Takashi Ozaki, Hamamatsu-shi (JP); Kosuke Onoyama, Hamamatsu-shi (JP); Hidetake Ogino, Hamamatsu-shi (JP); Makoto Kimura, Hamamatsu-shi (JP)

(21) Appl. No.: 16/122,156

(22) Filed: Sep. 5, 2018

Related U.S. Application Data
(63) Continuation of application No. PCT/JP2017/008969, filed on Mar. 7, 2017.

(30) Foreign Application Priority Data
Mar. 8, 2016 (JP) 2016-044073

(51) Int. Cl. H04L 12/24; G06F 3/0484; H04L 12/46

(52) U.S. Cl. CPC H04L 41/0806; G06F 3/04842; H04L 12/4641; H04L 41/12; H04L 41/0896; H04L 41/22

(57) ABSTRACT

Provided is a network setting information generation device capable of communicating with each of plural network devices and having a display control unit, a manipulation input unit, and an information generation unit. The display control unit displays figures corresponding to respective network devices on a display device. The manipulation input unit receives a manipulation for specifying a type of a virtual communication path to be formed between network devices and a manipulation for connecting plural ones of the figures along the virtual communication path. The information generation unit generates network setting information to be given to each of the network devices located at the two respective ends of the virtual communication path to form the virtual communication path, according to a connection mode of the figures on the display screen of the display device.

### CROSS REFERENCE TO RELATED APPLICATION(S)

This application is a continuation of the international patent application No. PCT/JP2017/008969 which was filed on Mar. 7, 2017, claiming the benefit of priority of Japanese Patent Application No. 2016-044073 filed on Mar. 8, 2016, the contents of which are incorporated herein by reference in its entirety.

### BACKGROUND OF THE INVENTION

### 1. Field of the Invention

The present invention relates to technique for setting a network device as a constituent element of a communication system.

### 2. Description of the Related Art

Specific examples of such a network device are a server and a terminal device which are to serve as a terminal node of a communication system and a router which is to serve as an intermediate node. In recent years, it has become possible to construct a VPN (virtual private network) by forming, according to IPsec or the like, an encrypted communication path between network devices that are connected to a general, public network such as the Internet and thereby perform a data communication that secures secrecy without the need for laying a dedicated line. In the following description, a logical communication path, such as the above-mentioned encrypted communication path, that is formed according to a particular communication protocol will be referred to as a “virtual communication path” so as to be discriminated from a physical communication path such as a dedicated line.

A specific example, other than IPsec, of the communication protocol for forming a virtual communication path is PPTP (Point-to-Point Tunneling Protocol). To form a virtual communication path between network devices, it is necessary to store information for formation of the virtual communication path in advance in each of the network devices located at the two respective ends of the virtual communication path. In the following description, information that is stored in a network device to cause it to perform a particular operation relating to a data communication will be referred to as “network setting information.” The network setting information for formation of a virtual communication path varies depending on the type of the virtual communication path, in other words, the type of a communication protocol that prescribes the virtual communication path. For example, in the case of a virtual communication path for an encrypted communication as in IPsec, an encryption key is stored in network devices located at the two respective ends of the virtual communication path in advance as network setting information. In the case of a virtual communication path that requires authentication prior to a start of a communication as in PPTP, its authentication type and authentication ID and a password are stored in network devices located at the two respective ends of the virtual communication path in advance as network setting information.

To generate network setting information, professional knowledge about communication protocols and professional knowledge about commands etc. to be used for setting work for that purpose were necessary. However, with the spread of network devices, situations are now found that a person who does not necessarily have expertise is obliged to, for example, generate network setting information. In view of this, various techniques have been proposed that allow a person without expertise to, for example, generate network setting information easily. One example of such techniques is disclosed in Patent Literature 1. The technique disclosed in Patent Literature 1 is a technique that makes it possible to construct a VLAN (virtual local area network) readily without expertise. In the technique disclosed in Patent Literature 1, figures such as icons corresponding to respective network devices are displayed on a display device. A user who wants to form a VLAN can generate network setting information for realizing the VLAN and give them to respective network devices by making, for example, a manipulation of connecting, by a line segment, figures corresponding to network devices that the user want to belong to the VLAN.

Patent Literature 1: JP-B-3896310

Patent Literature 2: JP-A-2004-254140

Patent Literature 3: JP-B-5769208

### SUMMARY OF THE INVENTION

However, the technique disclosed in Patent Literature 1 has a problem that a type of a virtual communication path to be formed between network devices cannot be specified and hence it is impossible to form any of various types of virtual communication paths between network devices.

The present invention has been made in view of the above problem, and an object of the invention is therefore to provide a technique that makes it possible to form any of various types of virtual communication paths between network devices by simple manipulations without expertise.

An aspect of the invention provides a network setting information generation method including: causing a display device to display figures corresponding to respective network devices as candidates of constituent elements of a communication system; receiving a manipulation for specifying a type of a virtual communication path to be formed between network devices and a manipulation for connecting plural one of the figures along the virtual communication path; and generating network setting information to be set in the respective network devices for forming the virtual communication path in accordance with a connection mode of the figures on a display screen of the display device.

An another aspect of the invention provides a network setting information generation device including: a display control unit that causes a display device to display figures corresponding to respective network devices as candidates of constituent elements of a communication system; a manipulation input unit that receives a manipulation for specifying a type of a virtual communication path to be formed between network devices and a manipulation for connecting plural ones of the figures along the virtual communication path; and an information generation unit that generates network setting information to be set in the respective network devices to form the virtual communication path in accordance with a connection mode of the figures on a display screen of the display device.

### BRIEF DESCRIPTION OF THE DRAWINGS

FIG. 1 is a diagram showing an example communication system 1 including a network setting information generation device 10 according to an embodiment of the present invention.

FIG. 2 is a diagram showing an example hardware configuration and an example software configuration of the network setting information generation device 10 according to the embodiment of the invention.

FIG. 3 is a flowchart showing a flow of a network setting information generation process that is run, according to generation assist programs, by a control unit 100 of the network setting information generation device 10 according to the embodiment of the invention.

FIG. 4 shows an example menu picture that the control unit 100 according to the embodiment of the invention causes a display unit 120a to display.

FIG. 5 shows an example virtual communication path formation assist picture that the control unit 100 according to the embodiment of the invention causes the display unit 120a to display in a virtual communication path forming process.

FIG. 6 shows an example bandwidth allocation assist picture that the control unit 100 according to the embodiment of the invention causes the display unit 120a to display in a bandwidth allocating process.

FIG. 7 shows an example filtering condition change assist picture that the control unit 100 according to the embodiment of the invention causes the display unit 120a to display in a filtering condition changing process.

FIGS. 8A and 8B are views for description of modification (2).

### DETAILED DESCRIPTION

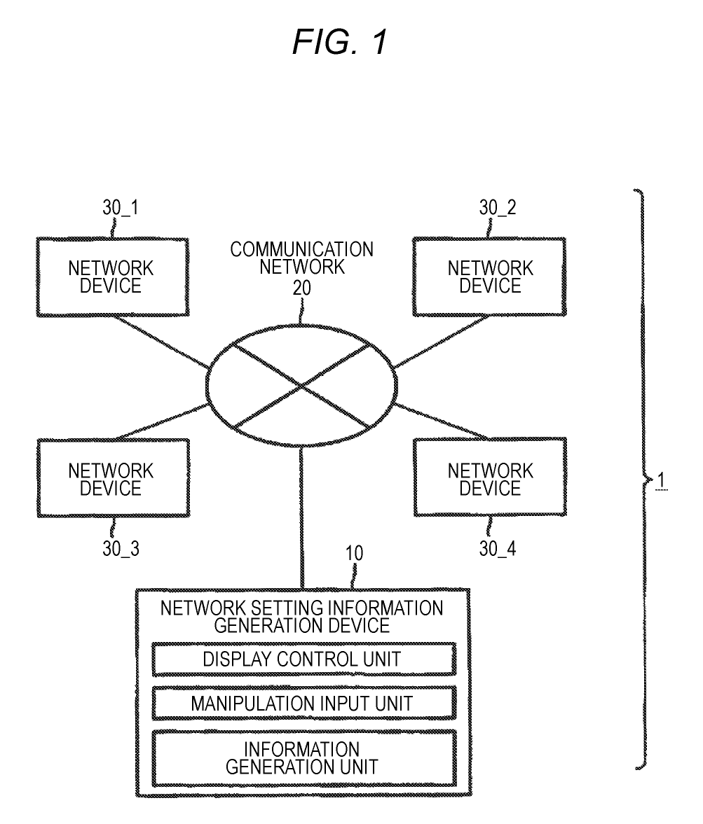

An embodiment of the present invention will be hereinafter described with reference to the drawings. FIG. 1 is a diagram showing an example communication system 1 including a network setting information generation device 10 according to the embodiment of the invention. The network setting information generation device 10 is a tablet terminal, for example, and is wire-connected to a communication network 20 such as the Internet. Although the embodiment will be directed to a case that the form of connection of the network setting information generation device 10 to the communication network 20 is wired connection, it may be wireless connection. The network setting information generation device 10 is not limited to a tablet terminal and may be a smartphone, a PDA (personal data assistant), or a notebook or stand-alone personal computer.

The communication system 1 includes network devices 30_n (n=1 to N; N may be any natural number (FIG. 1 shows a case of N being equal to 4)) besides the network setting information generation device 10. Each of the network devices 30_n (n=1 to N) is a router, for example, and a LAN (local area network; not shown in FIG. 1) that is laid at an installation location of each network device 30_n is connected to the communication network 20. In the following description, the network devices 30_n (n=1 to N) will be referred to as “network devices 30” if they need not be discriminated from each other. Although the embodiment will be directed to a case that the network devices are routers, they may be servers that provide various communication services such as an information distribution service using the communication network 20 or terminal devices as receiving devices of such a service.

In the communication system 1, any of various virtual communication paths such as IPsec, PPIP, and IPIP can be formed between network devices 30 by storing network setting information in the network devices 30. For example, by storing network setting information of IPsec in each of network devices 30_1 and 30_2, it is possible to form a virtual communication path of IPsec between the network devices 30_1 and 30_2 via the communication network 20 and have them perform an encrypted communication over the communication network 20. The network setting information is not limited to information relating to formation of a virtual communication path and contains information that prescribes a state of operation of a network device 30. Specific examples of the network setting information that prescribes a state of operation of a network device 30 are information indicating bandwidths allocated to respective communication protocols in the associated network device 30 and information indicating filtering conditions (i.e., conditions for passage and prohibition of passage of packets through the associated network device 30) in the associated network device 30.

The network setting information generation device 10 generates network setting information to be stored in a network device 30 according to user instructions and provides it to the network device 30 over the communication network 20.

Conventionally, it has been a common practice that an engineer having expertise such as a network manager performs generation etc. of network setting information. In contrast, the network setting information generation device 10 according to the embodiment is constructed so as to allow a user not having expertise to generate any of various types of virtual communication paths between network devices 30 by simple manipulations, that is, so as to be able to generate network setting information relating to a virtual communication path by simple manipulations without requiring expertise. This characterizes the embodiment. In addition, the network setting information generation device 10 according to the embodiment is constructed so as to be able to change the manners of operation of each network device 30. This also characterizes the embodiment. The network setting information generation device 10 which reflects features of the embodiment markedly will mainly be described below.

FIG. 1 is a functional block diagram of the network setting information generation device 10. As shown in FIG. 1, the network setting information generation device 10 has a display control unit, a manipulation input unit, and an information generation unit. The display control unit displays figures (icons) corresponding to the respective network devices 30_n on the display screen of a display device such as a liquid crystal display and thereby a user to make a manipulation for specifying a type of a virtual communication path and a manipulation for specifying two ends of the virtual communication path. The manipulation input unit accepts the above manipulations. As described later in detail, in the embodiment, two ends of a virtual communication path are specified by drawing, on the display screen, a line segment that originates from a figure corresponding to a network device 30 located at one end of a virtual communication path and reaches a figure corresponding to a network device 30 located at the other end of the virtual communication path. The information generation unit generates network setting information to be given to the network devices 30 located at the two ends of the virtual communication path, respectively, to form the virtual communication path, according to how the figures are connected to each other on the display screen. Network setting information to be given to each network device 30 may be generated by using, as appropriate, integrated management software that employs existing techniques such as SDN (software-defined networking).

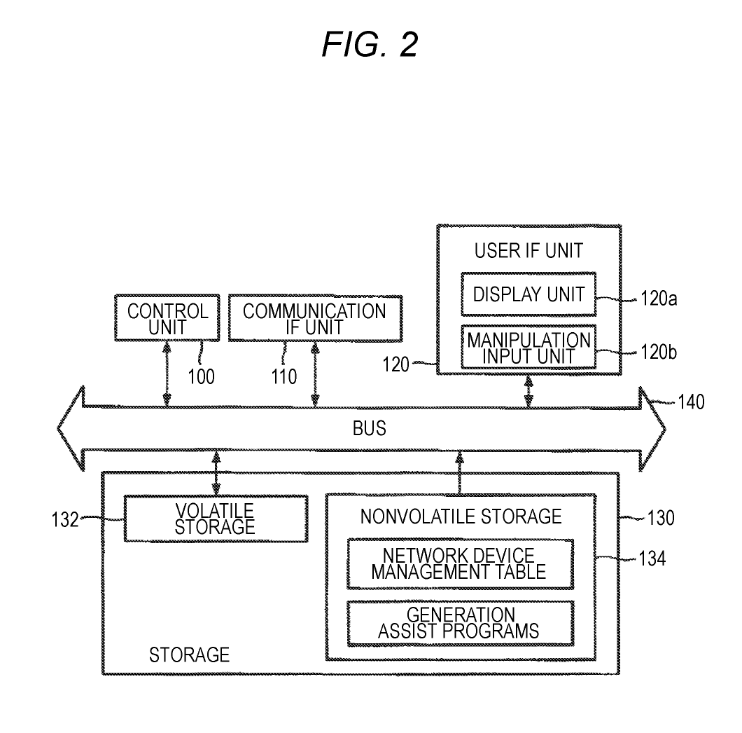

To implement the functional block configuration shown in FIG. 1, the network setting information generation device 10 has a hardware configuration and a software configuration shown in FIG. 2. As shown in FIG. 2, the network setting information generation device 10 has a control unit 100, a communication interface (hereinafter abbreviated as “IF”) unit 110, a user IF unit 120, a storage 130, and a bus 140 which enables data exchange between the above constituent elements.

The control unit 100 is a CPU (central processing unit), for example. The control unit 100 functions as the above-mentioned display control unit and the information generation unit by running generation assist programs that are stored in the storage 130 (more accurately, nonvolatile storage 134). The details of processes that are executed by the control unit 100 according to the generation assist programs will be described later.

The communication IF unit 110 is an NIC (network interface card), for example. The communication IF unit 110, which is connected to the communication network 20, receives data transmitted by the communication network 20 and passes it to the control unit 100 and, on the other hand, sends the communication network 20 data supplied from the control unit 100. In a mode in which the network setting information generation device 10 is connected to the communication network 20 wirelessly, a wireless LAN IF, for example, which communicates with a wireless LAN access point wirelessly may be used as the communication IF unit 110.

As shown in FIG. 2, the user IF unit 120 includes a display unit 120a and the above-mentioned manipulation input unit 120b. The display unit 120a is a display device such as a liquid crystal display and a drive circuit for performing a drive control on it (neither of which is shown in FIG. 2). The display unit 120a displays images representing various kinds of pictures under the control of the control unit 100. An example picture to be displayed by the display unit 120a is a picture for prompting a user to make various kinds of inputs.

The manipulation input unit 120b is a sheet-like, transparent position detection sensor that is provided so as to cover the display screen of the display unit 120a. The position detection method of the manipulation input unit 120b may be of either a capacitance type or an electromagnetic induction type. The manipulation input unit 120b constitutes a touch panel together with the display unit 120a. A user can make various kinds of input manipulations by touching the manipulation input unit 120b with a touch pen, a fingertip, or the like or moving a fingertip or the like that is kept in contact with the manipulation input unit 120b. The manipulation input unit 120b provides the control unit 100 manipulation content data (e.g., coordinate data of a touch position on a two-dimensional coordinate space whose origin is, for example, the top-left corner of the display screen of the display unit 120a) indicating a touch position of, for example, a fingertip of the user. As a result, the manipulation content of the user is transmitted to the control unit 100. Although in the embodiment the sheet-like position detection sensor that forms the touch panel together with the display unit 120a is used as the display unit 120a, a mouse or a keyboard may be used as the manipulation input unit 120b.

The storage 130 includes a volatile storage 132 and a nonvolatile storage 134. The volatile storage 132 is a RAM (random access memory), for example. The volatile storage 132 is used by the control unit 100 as a working area when various kinds of programs such as the generation assist programs are run. The nonvolatile storage 134 is a flash ROM (read-only memory) or a hard disk drive, for example. The nonvolatile storage 134 is stored with various kinds of programs and data.

An example of the data stored in the nonvolatile storage 134 is a network device management table. The network device management table contains, for each type of virtual communication path, network setting information for formation of a virtual communication path with another network device. Each piece of network setting information is correlated with an identifier uniquely indicating one of the network devices 30_n (n=1 to N). A host name of a network device 30 or its communication address such as a MAC address or an IP address may be used as the identifier. The network device management table also contains network setting information indicating manners of operation of each of the network devices 30_n (n=1 to N) in such a manner that it is correlated with an identifier uniquely indicating the network device 30_n.

Specific examples of the network setting information for formation of a virtual communication path with another network device are as follows. For example, where a virtual communication path to be formed with another network device is IPsec, the network device management table contains, as network setting information, data indicating each of an IPsec protocol, an encoding algorithm, a hash function, an IP address of the other network device, a network address of the other network device, a type of a preshared key, and a value of the preshared key. For a network device 30 that can accommodate IPsec but to which no virtual communication path of IPsec is connected, the network setting information does not include an IP address and a network address of another network device. The same is true of other types of virtual communication paths described below.

Where a virtual communication path to be formed with another network device is PPTP, the network device management table contains, as network setting information, data indicating each of acceptable authentication type, an authentication ID and password, an IP address and a network address of the other network device. Where a virtual communication path to be formed with another network device is Dataconnect (however, the use of IPsec is a prerequisite), the network device management table contains, as network setting information, data indicating each of an IPsec protocol, an encoding algorithm, a hash function, an NGN telephone number of the other network device, a type of a preshared key, and a value of the preshared key. Where a virtual communication path to be formed with another network device is IPIP, the network device management table contains, as network setting information, data indicating each of an IP address and a network address of the other network device.

Examples of the programs stored in the nonvolatile storage 134 are the above-mentioned generation assist programs and a kernel for realizing an OS (operating system). Triggered by power-on (not shown) of the network setting information generation device 10, the control unit 100 reads out the kernel (not shown) from the nonvolatile storage 134 into the volatile memory 132 and starts its execution. While operating according to the kernel to realize the OS, the control unit 100 can run another program in response to an instruction that is given through the manipulation input unit 120b. For example, when instructed to run the generation assist programs through the manipulation input unit 120b, the control unit 100 reads the generation assist programs from the nonvolatile storage 134 into the volatile memory 132 and starts its execution.

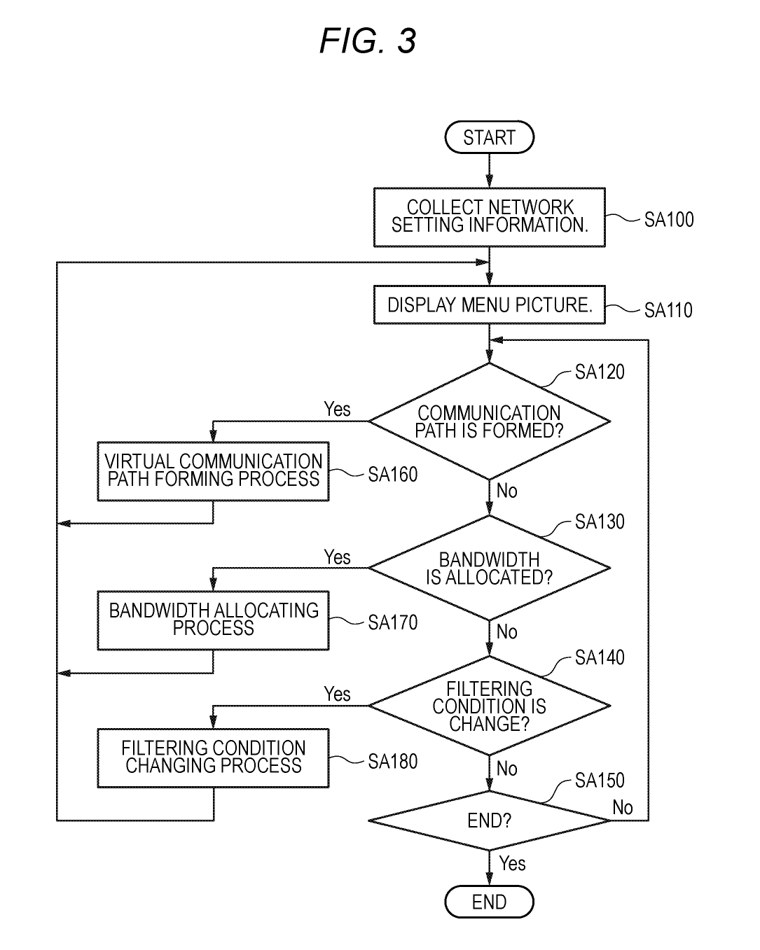

FIG. 3 is a flowchart showing a flow of a network setting information generation process that is run by the control unit 100 according to the generation assist programs. As shown in FIG. 3, first, the control unit 100 collects network setting information stored in the respective network devices 30_n (n=1 to N) by communicating with them over the communication network 20 and writes the collected data in the network device management table (step SA100). Then the control unit 100 causes the display unit 120a to display a menu picture for prompting a user to make manipulations for generating network setting information (step SA110).

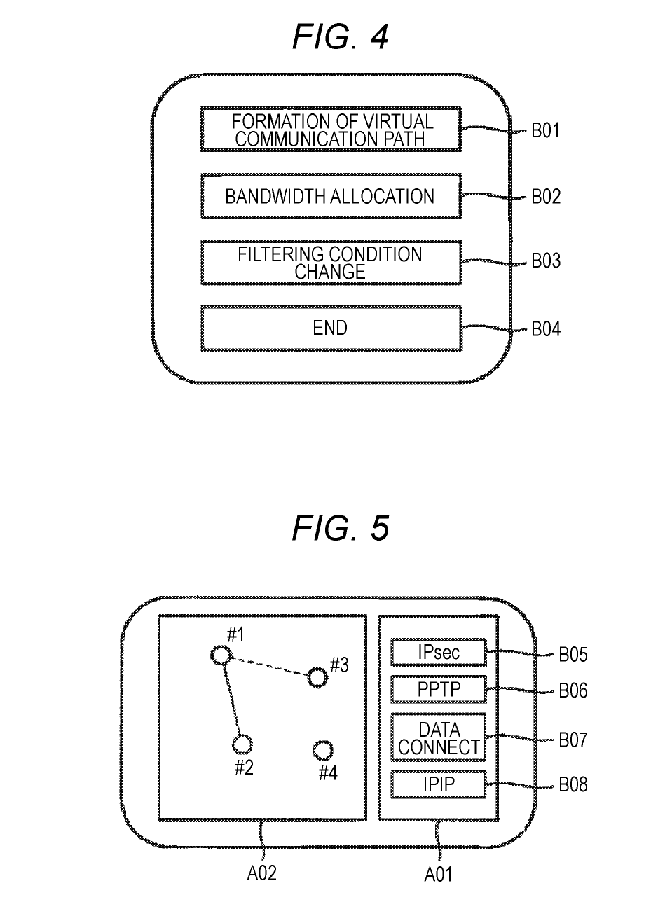

FIG. 4 shows an example menu picture that the control unit 100 causes the display unit 120a to display at step SA110. As shown in FIG. 4, the menu picture is provided with virtual manipulation items B01-B04 that are given character strings “formation of virtual communication path”, “bandwidth allocation”, “filtering condition change”, and “end” respectively. The user of the network setting information generation device 10 can instruct the control unit 100 to execute a process that is correlated with each virtual manipulation item by performing, on the manipulation input unit 120b, a manipulation of touching the virtual manipulation item.

In the following description, the virtual manipulation item B01 that is given the character string “formation of virtual communication path” will be referred to as a “virtual communication path formation button B01.” The virtual manipulation item B02 that is given the character string “bandwidth allocation” will be referred to as a “bandwidth allocation button B02.” The virtual manipulation item B03 that is given the character string “filtering condition change” will be referred to as a “filtering condition change button B03.” The virtual manipulation item B04 that is given the character string “end” will be referred to as an “end button B04.” The virtual communication path formation button B01 is a virtual manipulation item for causing a user to make an instruction to generate network setting information for formation of a new virtual communication path. The bandwidth allocation button B02 is a virtual manipulation item for causing the user to make an instruction to change an allocation of the bandwidth to a network device 30. The filtering condition change button B03 is a virtual manipulation item for causing the user to make an instruction to change the filtering conditions in a network device 30. The end button B04 is a virtual manipulation item for causing the user to make an instruction to finish the execution of the generation assist programs.

At steps SA120-SA150 which follow step SA110, the control unit 100 determines which of the above four virtual manipulation items has been touched by referring to manipulation content data that is supplied from the manipulation input unit 120b. More specifically, at step SA120, the control unit 100 waits for making of a manipulation on the manipulation input unit 120b (i.e., passing of manipulation content data from the manipulation input unit 120b), and determines whether the virtual communication path formation button B01 has been touched by referring to the manipulation content data. Even more specifically, the control unit 100 determines that a manipulation of touching the virtual communication path formation button B01 has been made if a coordinate position indicated by the manipulation content data is located in the region corresponding to the virtual communication path formation button B01. A similar determination is made of the other virtual manipulation items.

If the determination result of step SA120 is “Yes”, the control unit 100 executes a virtual communication path forming process (step SA160). After completion of the execution of the virtual communication path forming process, the control unit 100 again executes step SA110 onward. If the determination result of step SA120 is “No”, the control unit 100 determines whether the bandwidth allocation button B02 has been touched by referring to the manipulation content data (step SA130). If the determination result of step SA130 is “Yes”, the control unit 100 executes a bandwidth allocating process (step SA170). After completion of the execution of the bandwidth allocating process, the control unit 100 again executes step SA110 onward. If the determination result of step SA130 is “No”, the control unit 100 determines whether the filtering condition change button B03 has been touched (step SA140). If the determination result of step SA140 is “Yes”, the control unit 100 executes a filtering condition changing process (step SA180). After completion of the execution of the filtering condition changing process, the control unit 100 again executes step SA110 onward.

If the determination result of step SA140 is “No”, the control unit 100 determines whether the end button B04 has been touched (step SA150). If the determination result of step SA150 is “Yes”, the control unit 100 erases the menu picture and finishes the execution of the generation assist programs. If the determination result of step SA150 is “No”, that is, if the user touch position is none of the virtual manipulation items B01-B04, the control unit 100 determines that an invalid manipulation has been made and executes step SA120 again and waits for a manipulation of the user.

The processes that are executed by the control unit 100 at the respective steps SA160, SA170, and SA180 will be described below. First, the virtual communication path forming process which is executed by the control unit 100 at step SA160 shown in FIG. 3 will be described. The virtual communication path forming process includes a process for causing a user to specify a type of a virtual communication path to be formed newly in the communication system 1 and network devices to be placed at the two respective ends of the virtual communication path, a process for generating network setting information for formation of the virtual communication path, and a process for giving the network setting information to the respective network devices that form the virtual communication path. In the virtual communication path forming process, to prompt the user to make a manipulation for specifying a type of a virtual communication path to be formed newly and a manipulation for specifying two respective ends of the virtual communication path, the control unit 100 causes the display unit 120a to display a virtual communication path formation assist picture shown in FIG. 5. A process for causing the display unit 120a to display the virtual communication path formation assist picture is a process executed by the above-mentioned display control unit.

As shown in FIG. 5, the virtual communication path formation assist picture is generally divided into a type selection menu area A01 and a virtual communication path display area A02. Virtual manipulation items B05-B08 that are given character strings indicating types of virtual communication paths such as IPsec, PPTP, Dataconnect, and IPIP, respectively, are arranged in the type selection menu area A01. The virtual manipulation items B05-B08 arranged in the type selection menu area A01 are virtual manipulation items for causing the user to specify a type of a virtual communication path to be formed newly. For example, if the user wants to newly form a virtual communication path of IPsec, a manipulation he or she is to perform on the manipulation input unit 120b is to touch the virtual manipulation item B05. A determination as to which of the virtual manipulation items B05-B08 has been touched may be made on the basis of a coordinate position indicated by manipulation content data like a determination as to whether the virtual communication path formation button B01 has been touched is made.

Figures (in the example shown in FIG. 5, circular icons) corresponding to the network devices 30_n (n=1 to N) are arranged in the virtual communication path display area A02. In the embodiment, to clarify what figures correspond to the respective network devices 30_n (n=1 to N), identifiers (in the example shown in FIG. 5, the identifiers are in the form of “#n”) are displayed in the vicinities of the respective figures. If it is determined at step SA100 on the basis of network setting information acquired from the respective network devices 30_n (n=1 to N) that a certain virtual communication path has already been formed, the control unit 100 draws, between the network devices located at the two respective ends of the virtual communication path, a line segment of a line type corresponding to the virtual communication path.

For example, in FIG. 5, a virtual communication path of IPsec is drawn by a solid line and a virtual communication path of PPTP is drawn by a broken line. That is, FIG. 5 shows an example that a virtual communication path of IPsec is formed between the network devices 30_1 and 30_2 and a virtual communication path of PPTP is formed between the network devices 30_1 and 30_3. By referring to the picture displayed in the virtual communication path display area A02, the user can visually recognize the virtual communication paths already formed in the communication system 1. Although in the embodiment a type of a virtual communication path is indicated by a type of a line segment that connects figures corresponding to respective network devices 30 located at the two respective ends of the virtual communication path, a type of a virtual communication path may be indicated by a color of the line segment.

The user who has visually recognized the virtual communication path formation assist picture can generate network setting information for formation of a new virtual communication path in a manner described below. First, the user performs, on the manipulation input unit 120b, a manipulation of touching one of the virtual manipulation items displayed in the type selection menu area A01. In this manner, a type of a virtual communication path to be formed newly can be specified. Then the user specifies network devices to be located at the two respective ends of the virtual communication path to be formed newly. A determination as to which of the network devices 30_n (n=1 to N) have been designated as the two respective ends of the new virtual communication path may also be made on the basis of coordinate positions indicated by manipulation content data.

When a type of a virtual communication path to be formed newly and network devices to be located at the two respective ends of the virtual communication path have been specified in the above-described manner, the control unit 100 generates network setting information to be given to the respective network devices by operating as the above-mentioned information generation unit. More specifically, first, the control unit 100 reads out related network setting information from the network device management table. A description will be made of an example case that IPsec has been designated as a type of a virtual communication path and the network devices 30_3 and 30_4 have been designated as network devices to be located at the two respective ends of the virtual communication path. In this case, the control unit 100 reads out, from the network device management table, network setting information (hereinafter referred to as “network setting information A”) relating to IPsec of the network setting information relating to the network device 30_3 and reads out network setting information (hereinafter referred to as “network setting information B”) relating to IPsec of the network setting information relating to the network device 30_4.

Subsequently, the control unit 100 adds the network setting information A and an IP address and a network address of the network device 30_3 to the network device management table as part of the network setting information relating to the network device 30_4 that prescribes the new virtual communication path. At this time, the control unit 100 provides this new network setting information to the network device 30_4. Likewise, the control unit 100 adds the network setting information B and an IP address and a network address of the network device 30_4 to the network device management table as part of the network setting information relating to the network device 30_3 that prescribes the new virtual communication path. At this time, the control unit 100 provides this new network setting information to the network device 30_3.

Where at least one of the network setting information A and the network setting information B includes data representing plural kinds of encryption algorithms, it is appropriate to cause the control unit 100 to execute a process of generating the above-mentioned new network setting information by selecting an encryption algorithm that is common to the network setting information A and the network setting information B. To prepare for a case that the network setting information A and the network setting information B have plural common encryption algorithms, priority order may be set for the encryption algorithms in advance. In this case, the control unit 100 may be caused to select an encryption algorithm according to the priority order. A similar measure may be taken for IPsec protocols and hash functions.

The control unit 100 sends a command (a command of the above-mentioned integrated management software) to form a virtual communication path according to the network setting information to each of the network devices 30_3 and 30_4 and finishes the virtual communication path forming process. Each of the network devices 30_3 and 30_4 executes a process corresponding to the command. As a result, a virtual communication path of IPsec is formed between the network devices 30_3 and 30_4. Incidentally, to form mesh-shaped virtual communication paths between plural network devices 30, the following process, for example, may be executed. For example, triggered by a manipulation, performed on the virtual communication path display area A02, for specifying a range including plural network devices 30 (e.g., a manipulation for specifying the top-left corner and the bottom-right corner of a rectangle representing that range), that is, a manipulation for selecting plural network devices 30 en bloc, the control unit 100 may be caused to execute a process of generating, in the above-described manner, network setting information to be given to each of the selected network devices 30. The details of the virtual communication path forming process have been described above.

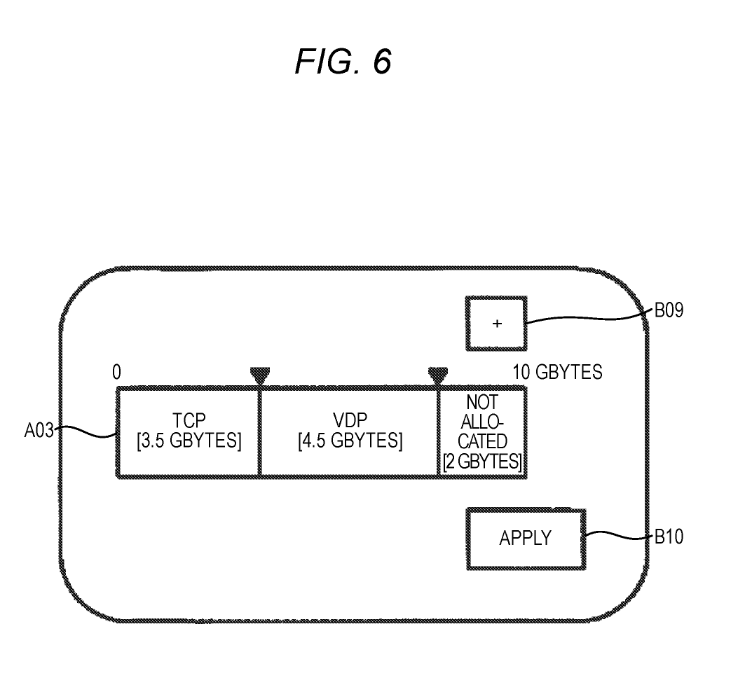

Next, the bandwidth allocating process which is performed by the control unit 100 at step SA170 shown in FIG. 3 will be described. In the bandwidth allocating process, the control unit 100 causes the display unit 120a to display a network device selection picture for prompting a user to specify a network device 30 for which the allocation of the bandwidth should be changed. Specific examples of the network device selection picture is an image in which identifiers of the respective network devices 30_n (n=1 to N) are arranged in list form and a picture obtained by cutting out the virtual communication path display area A02 of the virtual communication path formation assist picture (see FIG. 5). When one of the network devices 30_n (n=1 to N) is designated by a manipulation on the network device selection picture, the control unit 100 refers to network setting information relating to bandwidth allocation of the network setting information acquired from the network device 30 concerned at step SA100 and causes the display unit 120a to display a bandwidth allocation assist picture shown in FIG. 6. The process for causing the display unit 120a to display the network device selection picture and the process for causing the display unit 120a to display the bandwidth allocation assist picture are also processes executed by the above-mentioned display control unit.

As shown in FIG. 6, the bandwidth allocation assist picture includes a bandwidth display area A03 and two virtual manipulation items, that is, an add button B09 and an apply button B10. A second figure (in the embodiment, horizontal bar graph image) indicating bandwidths allocated to respective packet types in the network device 30 as the target of the bandwidth allocation change is displayed in the bandwidth display area A03. Although in the embodiment the horizontal bar graph image is used as the second figure indicating bandwidths allocated to respective communication protocols, a pie graph image may be used instead. The user can change the bandwidth allocation ratio by tapping a boundary line of the graph and moving it leftward or rightward. The add button B09 is a manipulation item for causing a user to make an instruction to add a communication protocol for which a bandwidth should be allocated newly. The apply button B10 is a manipulation item for causing a user to make an instruction to generate network setting information that prescribes bandwidth allocation at the allocation ratio shown in the bandwidth display area A03. Upon detection of a touch on the apply button B10, the control unit 100 executes a process as the information generation unit, that is, a process of generating network setting information that prescribes bandwidth allocation at the allocation ratio shown in the bandwidth display area A03. Subsequently, the control unit 100 updates the contents of the network device management table using the generated network setting information and sends, to the change target network device 30, the generated network setting information and a command to perform bandwidth allocation according to this network setting information, whereupon the control unit 100 finishes the bandwidth allocating process.

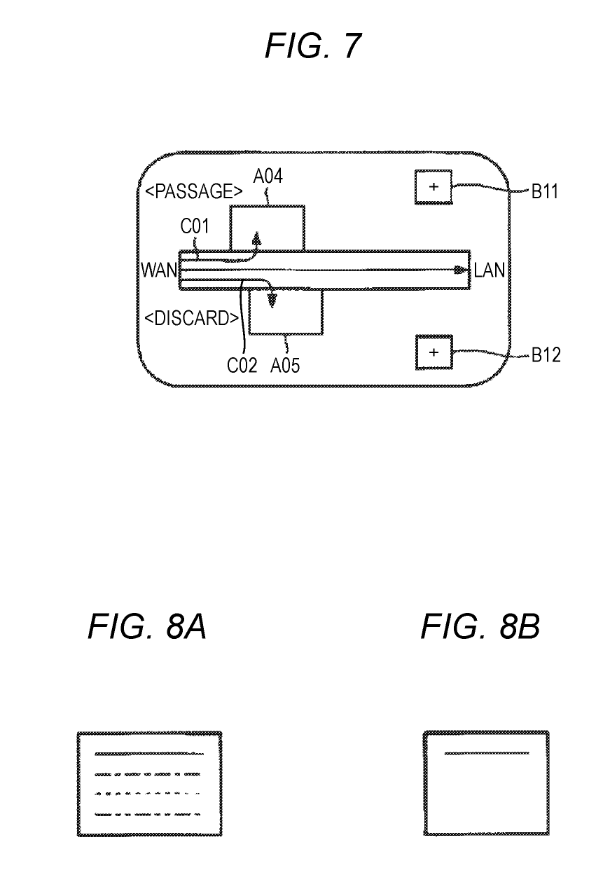

Next, the filtering condition changing process which is executed by the control unit 100 at step S180 shown in FIG. 3 will be described. Also in the filtering condition changing process, the control unit 100 causes the display unit 120a to display a network device selection picture for causing a user to specify a network device for which filtering conditions should be changed. When one of the network devices 30_n (n=1 to N) is designated by a manipulation on the network device selection picture, the control unit 100 refers to network setting information relating to filtering conditions of the network setting information acquired from the network device 30 concerned at step SA100 and causes the display unit 120a to display a filtering condition change assist picture shown in FIG. 7. The process for causing the display unit 120a to display the network device selection picture and the process for causing the display unit 120a to display the filtering condition change assist picture are also processes executed by the above-mentioned display control unit.

Arrow figures C01 and C02, display areas A04 and A05, and add buttons B11 and B12 are arranged in the filtering condition change assist picture. The figure C01 represents packets whose passage from the WAN (communication network 20) side to the LAN side is permitted, that is, packets that are allowed to pass through the network device 30, and conditions (e.g., conditions relating to a transmission source address and a transmission destination address) that such packets should satisfy are displayed in the display area A04. The figure C01 represents packets that are not allowed to pass through the network device 30, that is, packets that are discarded even if received from the WAN side, and conditions that such packets should satisfy are displayed in the display area A05. In the filtering condition change assist picture shown in FIG. 7, the figures C01 and C02 and the display areas A04 and A05 serve as second figures that indicate filtering conditions in the network device 30.

The add button B11 is a virtual manipulation item for causing a user to add a type of packets to be allowed to pass through the network device 30. When the add button B11 is touched, the control unit 100 displays an input prompt in the display area A04 and accepts input of new conditions. Likewise, the add button B12 is a virtual manipulation item for causing a user to add a type of packets to be discarded in the network device 30. When the add button B12 is touched, the control unit 100 displays an input prompt in the display area A05 and accepts input of a new condition. Various modes are conceivable about the timing of update of network setting information indicating filtering conditions. For example, one conceivable mode is that the control unit 100 is caused to execute a process for generating network setting information indicating new filtering conditions on the basis of the contents of display in the display area A04 or A05 being triggered by completion of input to the display area A04 or A05, which is a process to be executed by the information generation unit. This process to be executed by the information generation unit may include input of new network setting information generated on the basis of the contents of display in the display area A04 or A05 to the network device management table and transmission of it to the change target network device 30. Furthermore, a configuration is possible in which the above-mentioned apply button B10 is provided in the filtering condition change assist picture and the control unit 100 is caused, triggered by manipulation of the apply button B10, to perform generation of new network setting information, update of the contents of the network device management table, and transmission of it to the change target network device 30.

As described above, the embodiment makes it possible to form any of various types of virtual communication paths between network devices 30 by simple manipulations even without expertise. In addition, the embodiment makes it possible to change a state of operation of a network device 30 (more specifically, an allocation of the bandwidth or filtering conditions in the network device 30) by simple manipulations even without expertise.

The one embodiment of the invention which has been described above may be subjected to the following modifications.

(1) Although the above embodiment is directed to the case that a virtual communication path for construction of a VPN is formed between network devices 30, the virtual communication path formed between network devices 30 is not limited to it. For example, the virtual communication path formed between network devices 30 may be a virtual communication path for forwarding, to a particular communication port of a second network device 30, data that is transmitted to a particular communication port of a first network device 30, that is, a virtual communication path for realizing port forwarding. This can be realized by, for example, disposing a virtual identifier for specifying a target communication port of port forwarding in the type selection menu area A01 of the virtual communication path formation assist picture shown in FIG. 5 and causing a user to make manipulations for specifying first and second network devices as mentioned above by designating figures displayed in the virtual communication path display area A02.

(2) The control unit 100 may be caused to execute, in response to a manipulation for selecting a figure displayed in the virtual communication path display area A02, a process for displaying a second figure indicating a state of operation of a network device 30 corresponding to the selected figure in such a manner that it is superimposed on the virtual communication path display area A02 or a process for pop-up-displaying the second figure. A second figure (for example, where a virtual communication path type is indicated by a line type, a legend image as a list of types of virtual communication paths that can be connected to the network device 30) indicating a type of a virtual communication path that can be connected to the network device 30 corresponding to a figure displayed in the virtual communication path display area A02 may be displayed in the vicinity of the figure (i.e., at a position related to the figure). A description will be made of an example case that virtual communication paths of IPsec, PPTP, Dataconnect, and IPIP are displayed by a solid line, a chain line, a broken line, and two-dot chain line, respectively. In the case of a network device 30 to which each of virtual communication paths of IPsec, PPTP, Dataconnect, and IPIP can be connected, a second figure may be displayed in the vicinity of a figure corresponding to the network device 30 in a form shown in FIG. 8A (i.e., a legend including a solid line, a chain line, a broken line, and two-dot chain line). On the other hand, in the case of a network device to which only a virtual communication path of IPsec can be connected, a second figure may be displayed in the vicinity of a figure corresponding to the network device 30 in a form shown in FIG. 8B (i.e., a legend including a solid line).

(3) Although in the above embodiment the display control unit and the information generation unit which reflect features of the network setting information generation device 10 according to the invention markedly are implemented by software, the network setting information generation device 10 may be constructed by implementing these units by hardware such as electronic circuits and combining these hardware with the manipulation input unit. Furthermore, although in the embodiment the network setting information generation device 10 assists formation of a virtual communication path and change of the manners of operation of a network device 30, the network setting information generation device 10 may assist only the former or the latter. For example, in a mode in which only the former is assisted, the control unit 100 may be such as to execute step SA160 immediately after completion of execution of step SA100 (see FIG. 3).

(4) Although in the above embodiment the network device management table is stored in the network setting information generation device 10, it may be stored in another storage device (e.g., network-compatible hard disk drive) that can be accessed by the network setting information generation device 10. Likewise, the various pictures such as the menu picture may be displayed on a display device that can be accessed by the network setting information generation device instead of the display unit of the network setting information generation device. In essence, it suffices that the network setting information generation device according to the invention have at least a display control unit which displays figures corresponding to respective network devices as candidates of constituent elements of a communication system on the display screen of a display device; a manipulation input unit which receives a manipulation for specifying a type of a virtual communication path to be formed between network devices and a manipulation for connecting figures along the virtual communication path; and an information generation unit which generates network setting information for formation of the virtual communication path according to a connection mode of the figures on the display screen.

Although in the above embodiment the display control unit, the manipulation input unit, and the information generation unit are provided in the single computer, a cloud-type system is possible in which these units are provided in separate computers and the network setting information generation method according to the invention is realized through cooperation between those computers. As another alternative, the display control unit, the manipulation input unit, and the information generation unit may be provided in one of the network devices 30 shown in FIG. 1 which therefore serves as the network setting information generation device 10. A further mode is conceivable in which the information generation unit is provided in one of the network devices 30 shown in FIG. 1, a computer (e.g., tablet terminal) that communicates with the network device is caused to function as the display control unit and the manipulation input unit, and the network setting information generation method according to the invention is realized through cooperation between the network device and the computer. In essence, it suffices that the invention be implemented as a communication system which has plural network devices each of which is connected to a communication network; a display control unit which displays figures corresponding to the respective network devices on the display screen of a display device; a manipulation input unit which receives a manipulation for specifying a type of a virtual communication path to be formed between network devices and a manipulation for connecting figures along the virtual communication path; and an information generation unit which generates network setting information for formation of the virtual communication path according to a connection mode of the figures on the display screen.

As described above, the invention provides, as the network setting information generation device which generates network setting information in respective network devices, the device having the following display control unit, manipulation input unit, and information generation unit. The display control unit causes the display device to display figures such as icons corresponding to respective network devices as candidates of constituent elements of a communication system. The manipulation input unit receives a manipulation for specifying a type of a virtual communication path to be formed between network devices and a manipulation for connecting plural figures along the virtual communication path. The information generation unit generates network setting information to be set in the respective network devices to form the virtual communication path, according to a connection mode of the figures on the display screen of the display device. In causing the display device to display figures corresponding to respective network devices, to allow a user to easily recognize which network device each figure corresponds to, each figure may be displayed so as to be accompanied by an identifier (host name or communication address) that indicates a network device uniquely. The identifier may be displayed in response to the user's making a manipulation for selecting a figure.

According to the invention, network setting information for formation of a virtual communication path can be generated by intuitive and simple manipulations of specifying a type of the virtual communication path such as IPsec or PPTP and connecting figures corresponding to network devices located at the two respective ends of the virtual communication path, that is, connecting them by a line segment. The network setting information thus generated are given to the network devices corresponding to the two respective ends of the line segment and the network devices are caused to operate according to the respective network setting information, whereby the virtual communication path is formed between the network devices. According to the invention, a user need not have such professional knowledge as what network setting information should be generated for each type of a virtual communication path and professional knowledge about various commands. And it becomes possible to form any of various types of virtual communication paths between network devices by simple manipulations.

Various modes are conceivable as to how to give a network device network setting information generated by the network setting information generation device according to the invention. For example, where the network setting information generation device according to the invention and the network device can communicate with each other over a communication network, it is appropriate to cause the information generation unit to execute a process of sending network setting information generated in the above-described manner to the network device over the communication network and to cause the network device to store the network setting information received over the communication network. Where the network setting information generation device according to the invention and the network device can communicate with each other directly, it is appropriate to equip each of the network setting information generation device and the network device with an external device interface for connection of a computer-readable recording medium such as a USB (universal serial bus) memory or a flash ROM (read-only memory) and to give network setting information to the network device via the recording medium. More specifically, the above-mentioned information generation unit is caused to execute a process of writing network setting information generated in the above-described manner to the recording medium connected to its own external device interface. Subsequently, the recording medium to which the network setting information has been written is connected to the external device interface of the network device and the network device is caused to execute a process of reading out the network setting information from the recording medium connected to its own external device interface and storing it. In the mode in which network setting information is given to the network device via the recording medium, no particular problems arise though as described above the process executed by the information generation unit is limited to generation of network setting information.

Patent Literature 2 discloses a technique for visualizing an allocation status of the bandwidth in a network device using icons. Patent Literature 3 discloses a technique for visualizing a network environment that is established using OverFlow. However, the techniques disclosed in Patent Literatures 2 and 3 are different from the invention because in these techniques network setting information for formation of a virtual communication path are not generated by intuitive and simple manipulations of specifying a type of the virtual communication path such as IPsec or PPTP and connecting figures corresponding to network devices located at the two respective ends of the virtual communication path.

For example, when a manipulation for selecting plural figures en bloc is performed on the manipulation input unit, the information generation unit generates network setting information for formation of mesh-shaped virtual communication paths between network devices corresponding to the plural figures respectively. The phrase “formation of mesh-shaped virtual communication paths” means forming a virtual communication path between each of, for example, N network devices (N: an integer that is larger than or equal to 2) and each of the other (N−1) network devices. Also, if a manipulation for selecting a partial region on the display screen is performed on the manipulation input unit and the region includes plural figures, the information generation unit determines that a manipulation for selecting the plural figures en block has been performed. These modes make it possible to form a mesh-shaped virtual communication paths readily.

Further, the display control unit causes the display device to display a second figure indicating at least one of a type of a virtual communication path that is connectable to each network device and a state of operation of the network device at a position that is related to the figure corresponding to the network device. This mode makes it possible to generate network setting information for formation of a new virtual communication path while visually recognizing a type of a virtual communication path that can be connected to each network device or a state of operation of the network device through the second figure.

Various display forms are conceivable for the second figure. One conceivable form is that the second figure is displayed beside, that is, in the vicinity of, the figure corresponding to a network device (i.e., at a position that is related to the figure). Where the second figure indicates a state of operation of the network device, triggered by an event that a selection manipulation for selecting one of the figures that corresponds to a network device is performed on the manipulation input unit, the display control unit may cause the display device to display the second figure for the network device. In this case, the information generation unit may execute a process of updating network setting information of the network device corresponding to the figure selected by the selection manipulation in response to an event that a manipulation directed to the second figure is performed on the manipulation input unit. The network setting information that is set in a network device is not limited to information for formation of a virtual communication path and may be information that defines an allocation of the bandwidth, information indicating filtering conditions, and other information. This mode makes it possible to recognize a state of operation of a network device intuitively through the second figure and to change the state of operation by making a manipulation on the second figure.

To attain the above object, the invention provides a network setting information generation method comprising the steps of causing a display device to display figures corresponding to respective network devices as candidates of constituent elements of a communication system; receiving a manipulation for specifying a type of a virtual communication path to be formed between network devices and a manipulation for connecting figures along the virtual communication path; and generating network setting information for formation of the virtual communication path according to a connection mode of the figures on the display screen. This network setting information generation method also makes it possible to form any of various types of virtual communication paths between network devices by simple manipulations without requiring expertise.

A program for causing a common computer (e.g., CPU) to perform the above network setting information generation method, that is, a program for causing the CPU to function as the above-mentioned display control unit and information generation unit, may be provided. Specific modes for providing such a program are a mode that the program is distributed being written to a computer-readable recording medium such as a CD-ROM (compact disc-read only memory) or a flash ROM (read-only memory) and a mode that the program is distributed by downloading it over an electric communication line. A common computer can function as a network setting information generation device according to the invention by causing it to operate according to the thus-delivered program and to cooperate with a manipulation input unit such as a touch panel.

1. A network setting information generation method comprising:
causing a display device to display figures corresponding to respective network devices as candidates of constituent elements of a communication system;
receiving a manipulation for specifying a type of a virtual communication path to be formed between network devices and a manipulation for connecting plural one of the figures along the virtual communication path; and
generating network setting information to be set in the respective network devices for forming the virtual communication path in accordance with a connection mode of the figures on a display screen of the display device.

2. The network setting information generation method according to claim 1, wherein in the process of generating the network setting information, when receiving a manipulation for selecting plural figures en bloc, network setting information for forming mesh-shaped virtual communication paths between network devices corresponding to the plural figures respectively is generated.

3. The network setting information generation method according to claim 2, wherein in the process of generating the network setting information, if a manipulation for selecting a partial region on the display screen of the display device is performed and the region includes plural figures, it is determined that a manipulation for selecting the plural figures en block has been performed.

4. The network setting information generation method according to claim 1, wherein in the process of causing the display device to display, a second figure indicating at least one of a type of a virtual communication path that is connectable to a network device and a state of operation of the network device at such a position that is related to the figure corresponding to the network device is displayed.

5. The network setting information generation method according to claim 4, wherein the second figure indicates a state of operation of the network device;
wherein triggered by an event that a selection manipulation for selecting one of the figures is performed, the second figure for the network device corresponding to the selected figure is displayed on the display device; and
wherein network setting information that prescribes a state of operation of the network device corresponding to the figure selected by the selection manipulation is updated in response to an event that a manipulation directed to the second figure is performed.

6. A network setting information generation device comprising:
at least one memory storing instructions; and
at least one processor configured to implement the stored instructions to execute a plurality of tasks, including:
a display control task that causes a display device to display figures corresponding to respective network devices as candidates of constituent elements of a communication system;
a manipulation input interface task that receives a manipulation for specifying a type of a virtual communication path to be formed between network devices and a manipulation for connecting plural ones of the figures along the virtual communication path; and
an information generation task that generates network setting information to be set in the respective network devices to form the virtual communication path in accordance with a connection mode of the figures on a display screen of the display device.

7. The network setting information generation device according to claim 6, wherein when a manipulation for selecting plural figures en bloc is performed on the manipulation input interface task, the information generation task generates network setting information for formation of mesh-shaped virtual communication paths between network devices corresponding to the plural figures respectively.

8. The network setting information generation device according to claim 7, wherein if a manipulation for selecting a partial region on the display screen of the display device is performed on the manipulation input interface task and the region includes plural figures, the information generation task determines that a manipulation for selecting the plural figures en block has been performed.

9. The network setting information generation device according to claim 6, wherein the display control task displays a second figure indicating at least one of a type of a virtual communication path that is connectable to a network device and a state of operation of the network device at such a position that is related to the figure corresponding to the network device.

10. The network setting information generation device according to claim 9, wherein the second figure indicates a state of operation of the network device;
wherein triggered by an event that a selection manipulation for selecting one of the figures is performed on the manipulation input interface task, the display control task causes the display device to display the second figure for the network device corresponding to the selected figure; and
wherein the information generation task updates network setting information that prescribes a state of operation of the network device corresponding to the figure selected by the selection manipulation in response to an event that a manipulation directed to the second figure is performed on the manipulation input interface task.

11. The network setting information generation device according to claim 6, wherein the information generation task provides the network setting information generated based on the connection mode of the figures on the display screen of the display device to network devices corresponding to the respective figures.

12. The network setting information generation device according to claim 11, wherein the information generation task provides the network setting information generated based on the connection mode of the figures on the display screen of the display device to the network devices corresponding to the respective figures over a communication network that enables a communication with the network devices.

13. The network setting information generation device according to claim 6, wherein the information generation task writes the network setting information generated based on the connection mode of the figures on the display screen of the display device to a recording medium that is connected to an external device interface.

14. The network setting information generation device according to claim 6, wherein the display control task displays an identifier of a network device at a position that is related to the figure corresponding to the network device.

15. The network setting information generation device according to claim 14, wherein the display control task displays the identifier of the network device at the position that is related to the figure corresponding to the network device in accordance with a manipulation for selecting the figure corresponding to the network device.

16. The network setting information generation device according to claim 6, wherein when the network setting information is generated by the information generation task in accordance with the connection mode of the figures on the display screen of the display device, the generated network setting information is stored in a network device management table in which the network setting information and identifiers of the network devices corresponding to the respective figures are correlated with each other.

17. The network setting information generation device according to claim 16, wherein the network setting information that is correlated with each of the respective identifiers in the network device management table further includes information indicating a state of operation of the network device corresponding to its identifier.

18. The network setting information generation device according to claim 17, wherein the state of operation includes at least one of an allocation of a bandwidth and a filtering condition.

19. The network setting information generation device according to claim 6, wherein at least one of virtual communication paths of IPsec, PPTP, Dataconnect, and IPIP is set between the network devices using the network setting information.

20. The network setting information generation device according to claim 6, wherein the network setting information includes a filtering condition;
wherein the display control task causes the display device to display a second figure that contains information indicating a condition for packets that are allowed to pass through the network device and a condition for packets that are prohibited from passing through the network device; and
wherein the information generation task updates the network setting information prescribing the filtering condition of the network device in response to a manipulation that is performed on the manipulation input interface task as a manipulation directed to the second figure.
